(19) United States
(12) Patent Application Publication
(10) Pub. No.: US 2026/0362254 A1
(43) Pub. Date: Nov. 12, 2026

(54) UPLINK TIMING MANAGEMENT FOR MULTI-TRANSMISSION AND RECEPTION POINT IN WIRELESS COMMUNICATION

(71) Applicant: APPLE INC., Cupertino, CA (US)

(72) Inventors: Hong He, San Jose, CA (US); Chunxuan Ye, San Diego, CA (US); Dawei Zhang, Saratoga, CA (US); Wei Zeng, San Diego, CA (US); Haitong Sun, Cupertino, CA (US); Chunhai Yao, Beijing (CN); Huaning Niu, San Jose, CA (US); Ankit Bhamri, Bad Nauheim (DE); Oghenekome Oteri, San Diego, CA (US); Jie Cui, San Jose, CA (US)

(21) Appl. No.: 19/109,258

(22) PCT Filed: Sep. 23, 2022
(86) PCT No.: PCT/CN2022/120994

§ 371 Date: Mar. 6, 2025

(51) Int. Cl. H04W 36/00

(52) U.S. Cl. CPC H04W 36/0072; H04W 36/00692; H04W 36/0077

(57) ABSTRACT

Embodiments herein describe systems, methods, and apparatuses to configure multiple Timing Advance Group (TAG) identities (IDs) to support multiple timing advance values for multi-transmission and reception point operation. The TAGs may be configured using a radio resource control (RRC) signal. A network node may send a user equipment a timing advance command comprising one or more TAG IDs associated with updated timing advances. The UE may use the timing advance command to update one or more timing advance values.

### TECHNICAL FIELD

This application relates generally to wireless communication systems, including supporting multiple timing advance values for multi-transmission and reception point operation.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a signal flow diagram for configuring and triggering multiple TAs in accordance with some embodiments.

FIG. 2 illustrates an ASN.1 code for the RRC signal structure in accordance with some embodiments.

FIG. 3 illustrates a timing advance command in accordance with some embodiments.

FIG. 4 illustrates a wireless communication system comprising two TRPs in an invalid TAG configuration for inter-Band CA in accordance with some embodiments.

FIG. 5 illustrates a wireless communication system comprising two TRPs in an invalid TAG configuration for intra-Band CA in accordance with some embodiments.

FIG. 6 illustrates a signal flow diagram that may be used to configure and report UE-assist information for TA acquisition for multi-TRP in accordance with some embodiments.

FIG. 7 illustrates an exemplified ASN.1 code in accordance with some embodiments.

FIG. 8 illustrates an enhanced TAC MAC-CE in accordance with a first embodiment in accordance with some embodiments.

FIG. 9 illustrates an enhanced TAC MAC-CE that may be used to update multiple TA values in accordance with some embodiments.

FIG. 10 illustrates an example architecture of a wireless communication system, according to embodiments disclosed herein.

FIG. 11 illustrates a system for performing signaling between a wireless device and a network device, according to embodiments disclosed herein.

### DETAILED DESCRIPTION

Various embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some of the goals of a communication network are low latency and high reliability. New mobile services that require low-latency and high reliability performance (e.g., ultra-reliable low latency communications (URLLC)) are emerging. Standards have been created to ensure these services are supported. While the 5G standard has been designed to address these services from the start, the evolution of 5G New Radio (NR) needs to continuously enhance the mobility robustness performance for these challenging scenarios.

A network communication system may benefit from uplink timing enhancements. For example, it may be useful for multi-input multi-output (MIMO) systems to use two timing advances (TAs) for uplink (UL) multi-downlink control information (DCI) for multi-transmission and reception point (TRP) operation. Accordingly, some embodiments herein provide multiple TAs for UL multi-DCI for multi-TRP operation. Additionally, some embodiments herein specify mechanisms and procedures of layer 1/layer 2 (L1/L2) based inter-cell mobility for mobility latency reduction. For instance, some embodiments explore TA management.

There are several open issues currently for how multiple TAs (e.g., two TAs) for UL multi-DCI for multi-TRP operation should be supported. For instance, a communication system may support two Timing Advance Groups (TAGs) for a serving cell associated with two TRPs. However, it remains undefined regarding how to determine the TAG identity (ID) or indicate the TAG ID to the UE. Further, for carrier aggregation cases (e.g., intra-band carrier aggregation case), certain restrictions on TAG configuration may be desirable to simplify UE implementation for TAG management. Another open issue is regarding how the network can determine the time instance to trigger TA acquisition for the second TRP for a given UE to make two-TAs operation more efficiency. Additionally, in 3GPP release-17, a single TA is updated by a medium access control control element (MAC-CE) command. For multi-TRP with two TAs, enhancement may be needed to timely update one or two TAs using a single MAC-CE.

Embodiments herein address these open issues. Accordingly, embodiments herein may provide enhancements to a network communication system that allow the system to support multiple TAs.

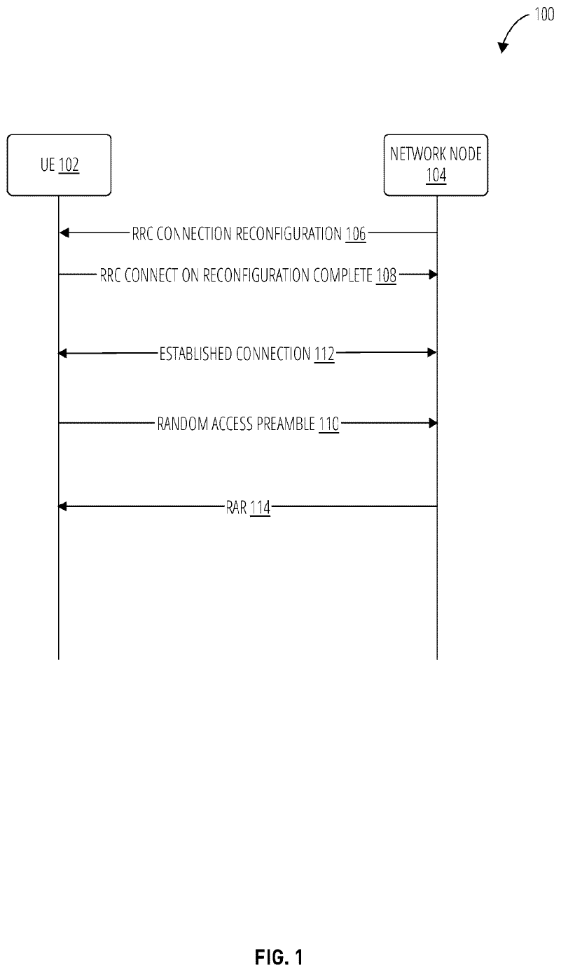

FIG. 1 illustrates a signal flow diagram 100 for configuring and triggering multiple TAs in accordance with some embodiments. As shown, the network node 104 may encode and transmit a radio resource control (RRC) signal (e.g., RRC connection reconfiguration 106) to configure the UE 102. The UE 102 may decode the RRC connection reconfiguration 106 and use information within the RRC connection reconfiguration 106 for configuration. The UE 102 an RRC connection reconfiguration complete 108 signal to the network node 104 to indicate successful completion of the configuration and form an established connection 112 with the network node 104.

The RRC signal (e.g., RRC connection reconfiguration 106) from the network node 104 may be used to configure two TAGs for a serving cell. A variety of approaches may be used to inform the UE 102 of the TAG IDs for the two TAGs belonging to a serving cell towards two TRPs.

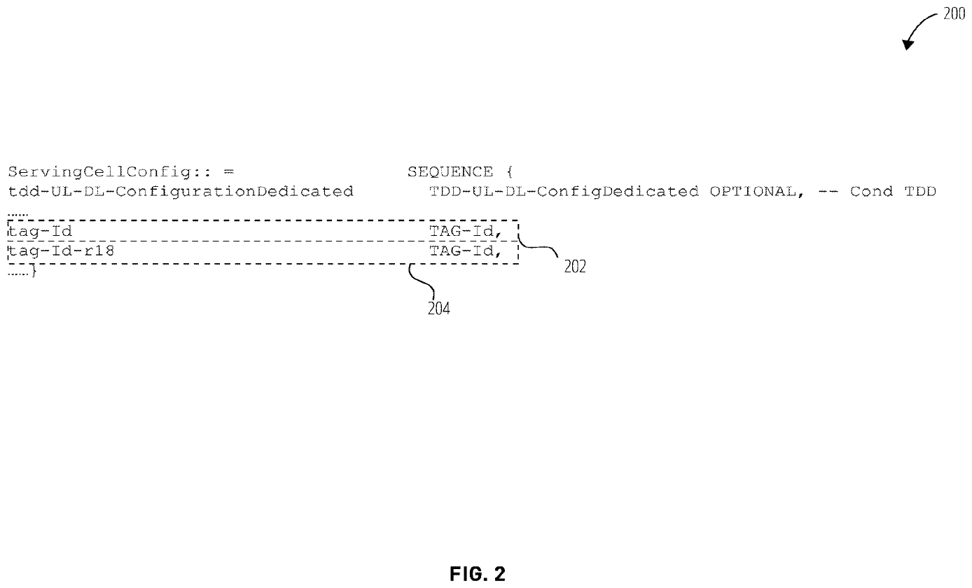

In some embodiments, the RRC signal may comprise two TAG IDs. In other words, the RRC signal may be used to explicitly configure the two TAGs for a serving cells with independent TAG IDs. For example, FIG. 2 illustrates an ASN.1 code 200 for the RRC signal structure. As shown in FIG. 2, the RRC signal may comprise a first TAG ID 202 and a second TAG ID 204. The UE 102 may decode the RRC signal to determine that the first TAG ID 202 is associated with a first TRP and the second TAG ID 204 is associated with a second TRP. This code 200 may enhance the current RRC framework by adding a row for a single serving cell to provide two TAG IDs. Accordingly, in some embodiments, the network node 104 may provide the UE 102 with two TAG IDs in a single RRC message.

In some embodiments, the RRC signal may comprise a single TAG ID and the UE 102 may determine a second TAG ID based on the TAG ID from the RRC signal. For instance, the RRC signal may be used to configure a first TAG ID for a serving cell. The second TAG ID (TAG_2) may be implicitly determined based on the RRC-configured first TAG ID (TAG_1) as follows:

TAG_2=TAG_1+K

In some embodiments, the value of K may be a constant that is hard coded into the system. For example, in the above equation, the K value may be set to four. K may be related to the number of TAGs supported by the communication system. In some embodiments, the K value may be RRC configured on a per UE basis. For instance, the K value may be RRC configured based on the maximum TAGs that the UE 102 is configured to support at a given moment.

Whether the second TAG ID is explicitly configured, or the second TAG ID is implicitly determined, the following rule may be hard-encoded in specification. In some embodiments, the TAG of a smaller TAG ID is used for the serving cell or ‘coresetPoolIndex=0’ and the other larger TAG ID is used for non-serving cell or ‘coresetPoolIndex=1’.

Returning to FIG. 1, the UE 102 may send a random access preamble 110 to the network node 104 to request an uplink allocation. The network node 104 may reply with a random access response (RAR) 114. Such ‘RRC+RAR’ based signaling may be used by the UE 102 to obtain the two TAG IDs (e.g., as discussed in the above embodiments), and trigger the use of timing advances for the two TAGs. For example, the network node 104 may encode the RAR 114 to include timing advance command MAC CE.

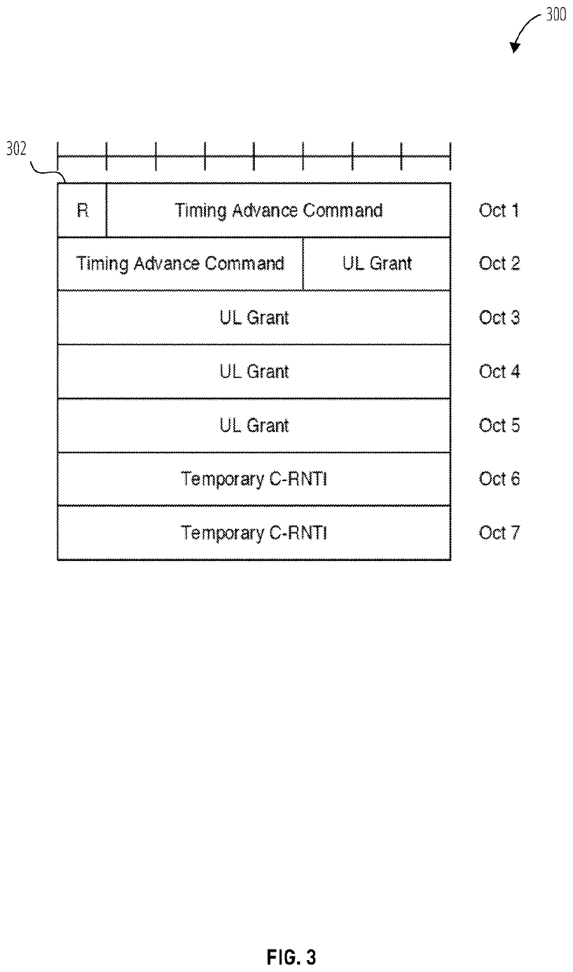

FIG. 3 illustrates a timing advance command 300 in a RAR message accordance with some embodiments. The timing advance command 300 may be encoded and transmitted by the network node 104 to the UE 102 in the RAR 114. The RAR message may include a bit field 302 indicating which of the two TAG IDs is associated with the timing advance command included in the RAR message. Timing advance command 300 is a MAC CE that is used to control uplink signal transmission timing. The timing advance command 300 may enable the UE 102 to adjust its uplink transmission to better align with the timing at the network side. This uplink adjustment may apply to Physical Uplink Shared Channel (PUSCH), Physical Uplink Control Channel (PUCCH), and Sounding Reference Signal (SRS). For example, the network node 104 may identify a timing difference between the uplink signals transmitted by the UE 102 and the network timing. The network node 104 may send the timing advance command 300 via a RAR 114 to cause the UE 102 to adjust future uplink transmission timing to make it better aligned with the subframe timing at the network side. If a PUSCH/PUCCH/SRS arrives at the network too early, the network node 104 may send a Timing Advance Command 300 to UE 102 indicating to transmit future signals later. Similarly, if the PUSCH/PUCCH/SRS arrives at the network too late, the network node 104 may send a Timing Advance Command 300 to UE 102 indicating to transmit future signals earlier.

In embodiments where two TAs are supported, there may be two TAGs. Accordingly, the network node 104 may indicate to the UE 102 which TAG ID to associate with the timing advance command 300. For example, the network node 104 may encode the bit field 302 with a value to indicate to the UE 102 which TAG ID is associated the timing advance command 300. In other words, the corresponding TAG ID for a TA value indicated by a RAR 114 may be indicated by the RAR MAC PDU by repurposing the 1-bit ‘R’ field as illustrated in FIG. 3. The bit field 302 may be set to a value ‘0’ to indicate to the UE to use the smaller TAG ID. The bit field 302 may be set to a value ‘1’ to indicate to the UE to use the larger TAG ID.

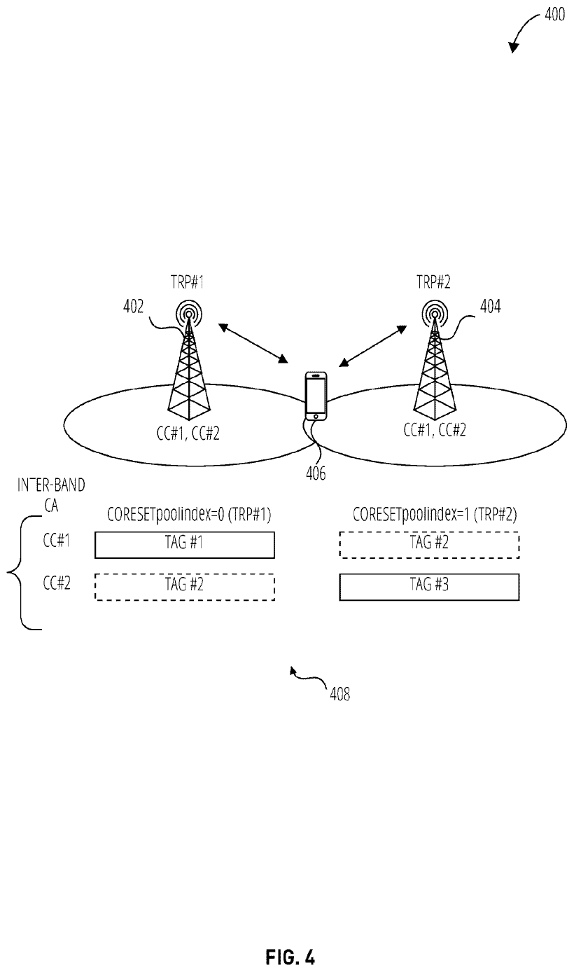

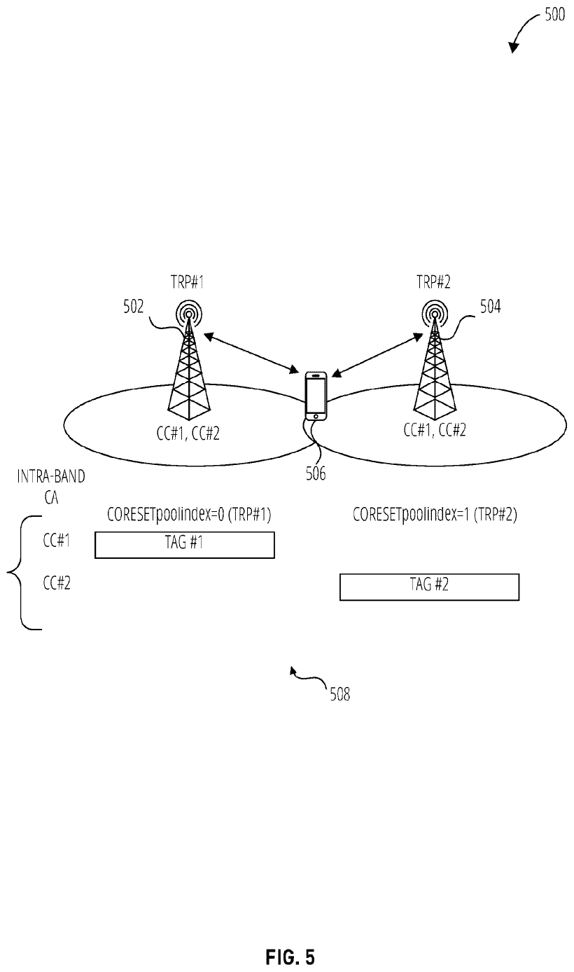

In some embodiments, various restrictions for TAG configuration maybe introduced for UE configured with Carrier Aggregation (CA). For carrier aggregation cases (especially intra-band CA cases), certain restriction on TAG configuration may be desirable to simplify UE implementation for TAG management. FIG. 4 and FIG. 5 illustrate invalid TAG configurations based on some possible restrictions.

FIG. 4 illustrates a wireless communication system 400 comprising two TRPs (i.e., first TRP 402, and second TRP 404) in an invalid TAG configuration 408 for inter-Band CA. As previously explained, the wireless communication system 400 may support two TAGs for a serving cell associated with two TRPs.

In some embodiments, in case of CA for a given UE 406, the UE 406 does not expect to receive TAG configurations where a single TAG is associated with different CORESETpoolindex values for different component carriers (CCs). Accordingly, the network may be expected to associate a different TAG for different CORESETpoolindex values for different. The UE 406 may validate that the TAG configuration meets this restriction requirement.

For instance, FIG. 4 includes an invalid TAG configuration 408 for multi-TRP use case for inter-Band CA. The invalid TAG configuration 408 comprises TAGs provided on a CC basis for each CORESETpoolindex. As shown, the network has configured CORESETpoolindex=0 (TRP #1) with TAG1 on CC1 and TAG2 on CC2. CORESETpoolindex=1 (TRP #2) has been configured with TAG2 on CC1 and TAG3 on CC2. In some embodiments, a UE 406 may determine that this TAG configuration is invalid and drop the configuration because CORESETpoolindex=1 is associated with TAG2 on CC1 and CORESETpoolindex=0 is associated with TAG2 on CC2.

In other words, in some embodiments, a given TAG is not allowed to be associated with different CORESETpoolindex values for different CCs. If the TAG associated with CC1 of CORESETpoolindex=1 where changed to TAG3 or TAG4, the TAG configuration would be valid. However, the UE 406 identifies the invalid TAG configuration 408 as invalid because TAG2 is associated with CC2 of the first TRP 402.

A technical consideration behind this restriction is that ‘CORESETpoolindex’ essentially serves as visual TRP ID. Hence, it may not be feasible to associate a single TAG (e.g., TAG #2) to two TRPs with different CORESETpoolindex values on different CCs.

FIG. 5 illustrates a wireless communication system 500 comprising two TRPs (i.e., first TRP 502, and second TRP 504) in an invalid TAG configuration 508 for intra-Band CA. In some embodiments, a same TAG is expected for intra-band CCs in CA case. For example, the UE 506 may expect CC1 and CC2 to have the same TAG. This restriction accounts for the fact that a single baseband (BB) operation (e.g., Fast Fourier Transform (FFT)), is desirable to simplify UE implementation and reduce power. Accordingly, the network may be expected to apply a single TAG for the intra-band CA. The UE 406 may validate that the TAG configuration meets this restriction requirement.

FIG. 5 provides an exemplified invalid TAG configuration 508 assuming two intra-band CCs. As shown, CC #1 is associated with TAG #1 toward TRP #1. CC #2 is associated with TAG #2 toward TRP #2. This provides an invalid configuration based on this restriction because the CCs have two different TAGs. A UE 406 may determine that this TAG configuration is invalid and drop the configuration.

In some embodiments, a UE may provide assist information for TA acquisition for multi-TRP. The UE assist information can be used by the network to determine determine a time instance to trigger TA acquisition for the second TRP for a given UE to make two-TAs operation more efficient. For instance, the UE may begin operating in a single TRP mode. Then as the UE identifies that it is nearing a TRP boundary, the UE provide to the network an indication of the UE location and the network may configure the UE to operate in a multi-TRP mode.

The UE assist information may include measurements taken by the UE. For example, in some embodiments, a new UE-assist information Downlink Time Difference (DL TD) maybe introduced. DL TD may be used by the network to determine whether to transmit PDCCH order for a second uplink timing acquisition toward the second TRP.

The DL TD may be defined as in Table 1.

TABLE 1

| | |
|---|---|
| Definition | The relative receiving timing difference |
| | at the UE side between the two TRPs |
| Applicable for | RRC_CONNECTED multi-TRP |

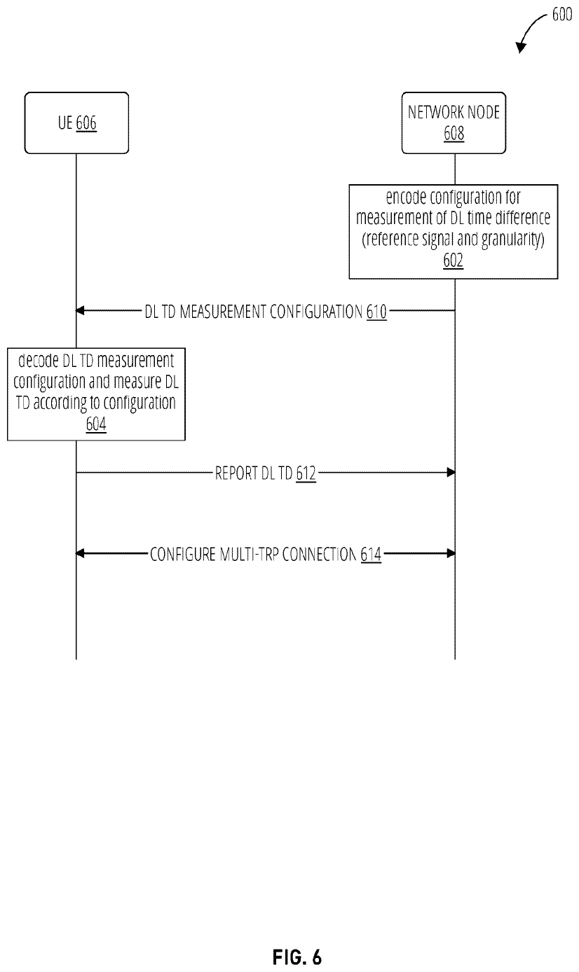

For example, FIG. 6 illustrates a signal flow diagram 600 that may be used to configure and report UE-assist information for TA acquisition for multi-TRP. The UE 606 may establish a first connection with a first TRP. The network node 608 may encode 602 a DL TD measurement configuration the DL TD measurement configuration comprising configuration details of reference signals from the first TRP and a second TRP that are used that are used for measuring a DL TD between the first TRP and the second TRP.

The network node 104 may send the DL TD measurement configuration 610 to the UE 606. The UE may receive and decode the DL TD measurement configuration 610. The UE 606 may measure 604, based on the DL TD measurement configuration 610, the DL TD to determine a relative receiving timing difference at the UE between two TRPs. For intra-cell multi-TRP where two TRPs have a same Physical Cell ID (PCI), various embodiments may use different methods to associate a measured signal (e.g., SSB, CSI-RS etc.) with respective TRPs.

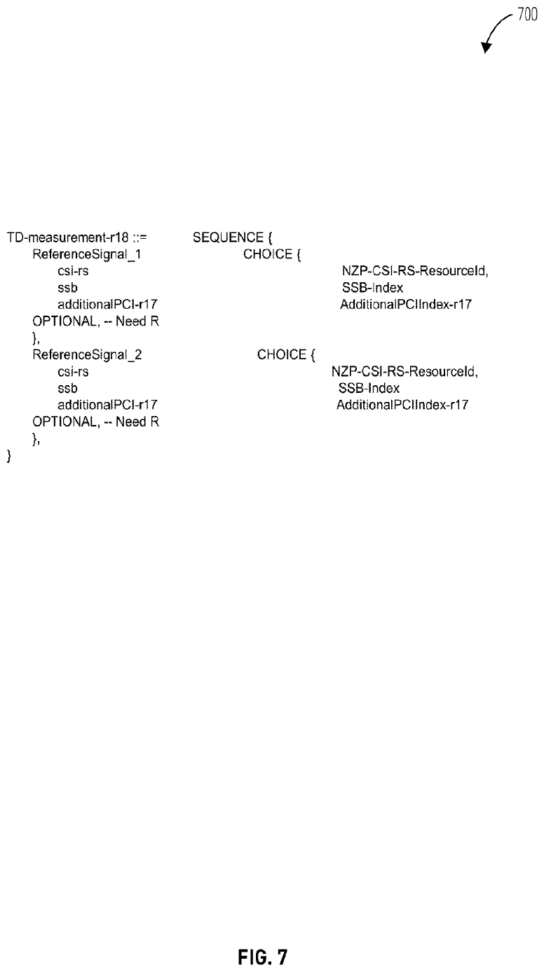

For example, in some embodiments, the reference signal used by the UE 606 for DL TD for two TRPs measurement may be configured by RRC signaling. FIG. 7 illustrates an exemplified ASN.1 code 700 to implement such an embodiment. The additionalPCI field indicates that the ReferenceSignal refers to an additional PCI different from serving cell PCI, as configured in servingCellConfig. The RRC signal may comprise details information to facilitate the measurement. For example, the RRC signal may comprise configuration details regarding candidate reference signals for the TRPs. The configuration details may include Channel State Information (csi)-rs configuration, a pointer to resourceID, and a synchronization signal block (SSB) index.

In some embodiments, the DL TD measurement configuration 610 may include pathloss RS signals associated with the indicated or active joint/DL Transmission Configuration Indicator (TCI) States. The pathloss RS signals associated with the indicated or active joint/DL TCI States may be use to measure the DL TD between two TRPs. For example, the UE 606 may reuse an established pathloss signal for the reference signals.

In some embodiments, the granularity of the DL TD report may be defined. For example, the reported range and granularity for the DL TD measurement of multi-TRP may be hard-encoded in 3GPP specification with a configurable resolution step of SxT_{c}. T_{c} may be a fixed value, and S may be configured by the network node 608. For example, S=2^{k}, where ‘k’ is configured by network and may be based on a UE capability report. Accordingly the UE may indicate a capability to support a certain granularity, and the may configure the range based on that capability.

The UE may measure 604 the DL TD according to configuration, and report DL TD 612 to the network node 104. Embodiments herein may use a variety of approaches to trigger the UE-Assist Information for DL TA measurement report. In some embodiments, a periodic DL TD report may be sent by the UE 606 on PUCCH or PUSCH. For these embodiments, UE 606 may be provided a set of parameters for PUSCH or PUCCH resources, periodicity (e.g., periodicDLTD-Timer) for reporting. In some embodiments, the network node 608 may control the periodicity based on UE mobility speed.

In some embodiments, the UE 606 may use Semi-Persistent (SP) DL TD (SP-DLTD) reporting on PUSCH or PUCCH. The periodicity and PUSCH resource may be configured for SP-DLTD reporting. In addition, the SP-DLTD reporting may be triggered by either a new MAC-CE in case of PUCCH resource or a new DCI format with cyclic redundancy check (CRC) bits being scrambled by a dedicated Radio Network Temporary Identifier (RNTI) (e.g., SP-DLTD-RNTI for PUSCH resource).

In some embodiments, the UE 606 may use aperiodic DL TD reporting (A-DLTD) reporting. The A-DLTD may be either triggered by DCI or occurrences of certain events. For example, in some embodiments, a new field may be added into scheduling DCI (e.g., TD-request) to trigger the A-DLTD reporting (e.g., one shot aperiodic DL TD report). In some embodiments the A-DLTD may be triggered if one or any of the following events occurs. The events may include a joint or UL TCI State associated with either ‘CORESTpoolIndex=1’ or additionalPCI of neighbor cellist is activated by MAC-CE, or additional PCI of active UL TCI State is updated/switched. Another events may include the measured DL TD value exceeding a threshold ‘T’. The value of the threshold ‘T’ may be hard-encoded in specification (e.g., using Cyclic Prefix (CP) length) or configured by network using System Information Block (SIB) or UE-dedicated RRC signaling. Yet another event may include an additionalPCI list is configured by RRC signaling. In some embodiments, a new field maybe added into scheduling DCI e.g., TD-request to trigger the A-DLTD reporting.

Based on the DL TD report, the network node 608 may configure a multi-TRP connection 614 for the UE 606. The UE 606 may operate with a single TRP to conserve power until it nears a TRP boundary. The network node 608 may be informed of the location of the UE 606 based on a DL TD reported by the UE 606. The network node 104 may send a multi-TRP configuration to the UE 606 for establishing a connection with a second TRP when the DL TD is equal or smaller than a threshold value. The UE 606 may establish a second connection with the second TRP based on the multi-TRP configuration while maintaining the first connection with the first TRP. The multi-TRP connection may establish multiple TAG and TAG IDs as discussed elsewhere herein.

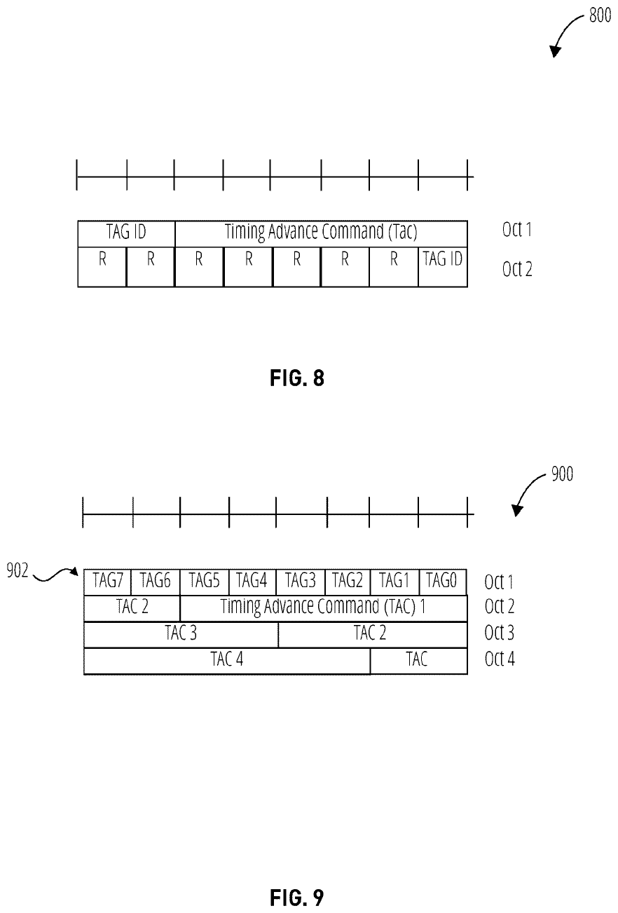

In some embodiments, for multi-TRP with two TAs, an enhancement timing command MAC-CE may facilitate updating one or two TAs using a single MAC-CE. FIG. 8 and FIG. 9 illustrate two approaches that may be used to indicate two timing advance commands (TACs) toward two TRPs. Commonly for both embodiments, a new TAC MAC-CE maybe introduced and identified by a dedicated MAC subheader.

FIG. 8 illustrates an enhanced TAC MAC-CE 800 in accordance with a first embodiment. The field size of TAG-ID is increased from 2-bits to 3-bits such that the addressable TAG number by TAC MAC-CE is extended to up to eight. Thus, the enhanced TAC MAC-CE 800 may be used to update a TA value of one of the eight TAGs.

FIG. 9 illustrates an enhanced TAC MAC-CE 900 that may be used to update multiple TA values. The enhanced TAC MAC-CE 900 may have a variable size and include the following field, as depicted in FIG. 9. The TAG ID field includes a bitmap field 902 to indicate the presence of a TAC field for each TAG. The TAGᵢ fields of the bitmap field 902 is set to one to indicate that the TAC field for the TAG ID i is included in the enhanced TAC MAC-CE 900. The TAGᵢ field is set to zero to indicate that the TAC field for the the TAG ID i is NOT included in the enhanced TAC MAC-CE 900. The TAC fields indicate the TA command value for the corresponding TAG.

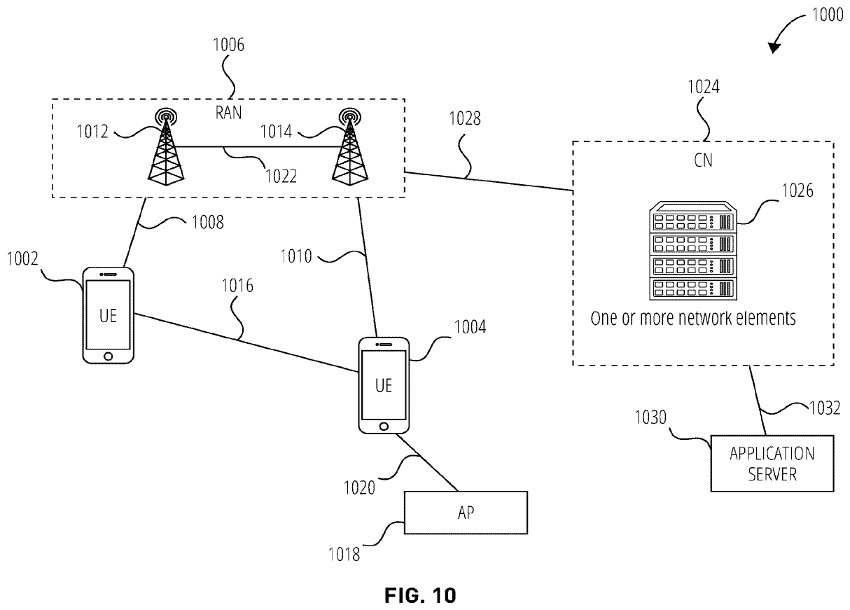

FIG. 10 illustrates an example architecture of a wireless communication system 1000, according to embodiments disclosed herein. The following description is provided for an example wireless communication system 1000 that operates in conjunction with the LTE system standards and/or 5G or NR system standards as provided by 3GPP technical specifications.

As shown by FIG. 10, the wireless communication system 1000 includes UE 1002 and UE 1004 (although any number of UEs may be used). In this example, the UE 1002 and the UE 1004 are illustrated as smartphones (e.g., handheld touchscreen mobile computing devices connectable to one or more cellular networks), but may also comprise any mobile or non-mobile computing device configured for wireless communication.

The UE 1002 and UE 1004 may be configured to communicatively couple with a RAN 1006. In embodiments, the RAN 1006 may be NG-RAN, E-UTRAN, etc. The UE 1002 and UE 1004 utilize connections (or channels) (shown as connection 1008 and connection 1010, respectively) with the RAN 1006, each of which comprises a physical communications interface. The RAN 1006 can include one or more base stations (such as base station 1012 and base station 1014) that enable the connection 1008 and connection 1010.

In this example, the connection 1008 and connection 1010 are air interfaces to enable such communicative coupling, and may be consistent with RAT(s) used by the RAN 1006, such as, for example, an LTE and/or NR.

In some embodiments, the UE 1002 and UE 1004 may also directly exchange communication data via a sidelink interface 1016. The UE 1004 is shown to be configured to access an access point (shown as AP 1018) via connection 1020. By way of example, the connection 1020 can comprise a local wireless connection, such as a connection consistent with any IEEE 802.11 protocol, wherein the AP 1018 may comprise a Wi-Fi® router. In this example, the AP 1018 may be connected to another network (for example, the Internet) without going through a CN 1024.

In embodiments, the UE 1002 and UE 1004 can be configured to communicate using orthogonal frequency division multiplexing (OFDM) communication signals with each other or with the base station 1012 and/or the base station 1014 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1012 or base station 1014 may be implemented as one or more software entities running on server computers as part of a virtual network. In addition, or in other embodiments, the base station 1012 or base station 1014 may be configured to communicate with one another via interface 1022. In embodiments where the wireless communication system 1000 is an LTE system (e.g., when the CN 1024 is an EPC), the interface 1022 may be an X2 interface. The X2 interface may be defined between two or more base stations (e.g., two or more eNBs and the like) that connect to an EPC, and/or between two eNBs connecting to the EPC. In embodiments where the wireless communication system 1000 is an NR system (e.g., when CN 1024 is a 5GC), the interface 1022 may be an Xn interface. The Xn interface is defined between two or more base stations (e.g., two or more gNBs and the like) that connect to 5GC, between a base station 1012 (e.g., a gNB) connecting to 5GC and an eNB, and/or between two eNBs connecting to 5GC (e.g., CN 1024).

The RAN 1006 is shown to be communicatively coupled to the CN 1024. The CN 1024 may comprise one or more network elements 1026, which are configured to offer various data and telecommunications services to customers/subscribers (e.g., users of UE 1002 and UE 1004) who are connected to the CN 1024 via the RAN 1006. The components of the CN 1024 may be implemented in one physical device or separate physical devices including components to read and execute instructions from a machine-readable or computer-readable medium (e.g., a non-transitory machine-readable storage medium).

In embodiments, the CN 1024 may be an EPC, and the RAN 1006 may be connected with the CN 1024 via an S1 interface 1028. In embodiments, the S1 interface 1028 may be split into two parts, an S1 user plane (S1-U) interface, which carries traffic data between the base station 1012 or base station 1014 and a serving gateway (S-GW), and the S1-MME interface, which is a signaling interface between the base station 1012 or base station 1014 and mobility management entities (MMEs).

In embodiments, the CN 1024 may be a 5GC, and the RAN 1006 may be connected with the CN 1024 via an NG interface 1028. In embodiments, the NG interface 1028 may be split into two parts, an NG user plane (NG-U) interface, which carries traffic data between the base station 1012 or base station 1014 and a user plane function (UPF), and the S1 control plane (NG-C) interface, which is a signaling interface between the base station 1012 or base station 1014 and access and mobility management functions (AMFs).

Generally, an application server 1030 may be an element offering applications that use internet protocol (IP) bearer resources with the CN 1024 (e.g., packet switched data services). The application server 1030 can also be configured to support one or more communication services (e.g., VOIP sessions, group communication sessions, etc.) for the UE 1002 and UE 1004 via the CN 1024. The application server 1030 may communicate with the CN 1024 through an IP communications interface 1032.

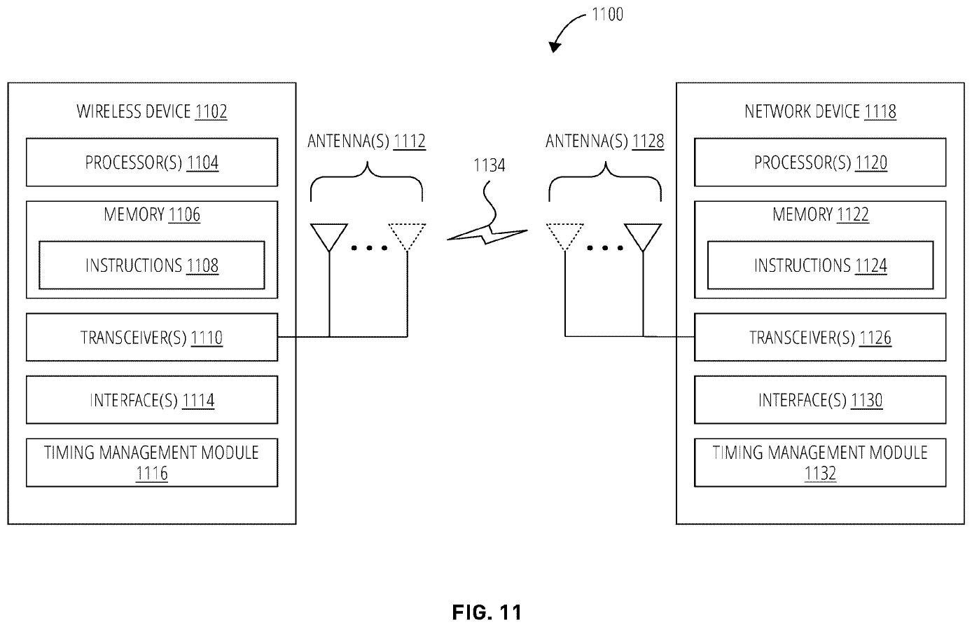

FIG. 11 illustrates a system 1100 for performing signaling 1134 between a wireless device 1102 and a network device 1118, according to embodiments disclosed herein. The system 1100 may be a portion of a wireless communications system as herein described. The wireless device 1102 may be, for example, a UE of a wireless communication system. The network device 1118 may be, for example, a base station (e.g., an eNB or a gNB) of a wireless communication system.

The wireless device 1102 may include one or more processor(s) 1104. The processor(s) 1104 may execute instructions such that various operations of the wireless device 1102 are performed, as described herein. The processor(s) 1104 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1102 may include a memory 1106. The memory 1106 may be a non-transitory computer-readable storage medium that stores instructions 1108 (which may include, for example, the instructions being executed by the processor(s) 1104). The instructions 1108 may also be referred to as program code or a computer program. The memory 1106 may also store data used by, and results computed by, the processor(s) 1104.

The wireless device 1102 may include one or more transceiver(s) 1110 that may include radio frequency (RF) transmitter and/or receiver circuitry that use the antenna(s) 1112 of the wireless device 1102 to facilitate signaling (e.g., the signaling 1134) to and/or from the wireless device 1102 with other devices (e.g., the network device 1118) according to corresponding RATs.

The wireless device 1102 may include one or more antenna(s) 1112 (e.g., one, two, four, or more). For embodiments with multiple antenna(s) 1112, the wireless device 1102 may leverage the spatial diversity of such multiple antenna(s) 1112 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1102 may be accomplished according to precoding (or digital beamforming) that is applied at the wireless device 1102 that multiplexes the data streams across the antenna(s) 1112 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1102 may implement analog beamforming techniques, whereby phases of the signals sent by the antenna(s) 1112 are relatively adjusted such that the (joint) transmission of the antenna(s) 1112 can be directed (this is sometimes referred to as beam steering).

The wireless device 1102 may include one or more interface(s) 1114. The interface(s) 1114 may be used to provide input to or output from the wireless device 1102. For example, a wireless device 1102 that is a UE may include interface(s) 1114 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1110/antenna(s) 1112 already described) that allow for communication between the UE and other devices and may operate according to known protocols (e.g., Wi-Fi®, Bluetooth®, and the like).

The wireless device 1102 may include a timing management module 1116. The timing management module 1116 may be implemented via hardware, software, or combinations thereof. For example, the timing management module 1116 may be implemented as a processor, circuit, and/or instructions 1108 stored in the memory 1106 and executed by the processor(s) 1104. In some examples, the timing management module 1116 may be integrated within the processor(s) 1104 and/or the transceiver(s) 1110. For example, the Timing management module 1116 may be implemented by a combination of software components (e.g., executed by a DSP or a general processor) and hardware components (e.g., logic gates and circuitry) within the processor(s) 1104 or the transceiver(s) 1110.

The timing management module 1116 may be used for various aspects of the present disclosure, for example, aspects of FIGS. 1-9. The timing management module 1116 is configured to support multiple TAs for multi-TRP operation.

The network device 1118 may include one or more processor(s) 1120. The processor(s) 1120 may execute instructions such that various operations of the network device 1118 are performed, as described herein. The processor(s) 1120 may include one or more baseband processors implemented using, for example, a CPU, a DSP, an ASIC, a controller, an FPGA device, another hardware device, a firmware device, or any combination thereof configured to perform the operations described herein.

The network device 1118 may include a memory 1122. The memory 1122 may be a non-transitory computer-readable storage medium that stores instructions 1124 (which may include, for example, the instructions being executed by the processor(s) 1120). The instructions 1124 may also be referred to as program code or a computer program. The memory 1122 may also store data used by, and results computed by, the processor(s) 1120.

The network device 1118 may include one or more transceiver(s) 1126 that may include RF transmitter and/or receiver circuitry that use the antenna(s) 1128 of the network device 1118 to facilitate signaling (e.g., the signaling 1134) to and/or from the network device 1118 with other devices (e.g., the wireless device 1102) according to corresponding RATs.

The network device 1118 may include one or more antenna(s) 1128 (e.g., one, two, four, or more). In embodiments having multiple antenna(s) 1128, the network device 1118 may perform MIMO, digital beamforming, analog beamforming, beam steering, etc., as has been described.

The network device 1118 may include one or more interface(s) 1130. The interface(s) 1130 may be used to provide input to or output from the network device 1118. For example, a network device 1118 that is a base station may include interface(s) 1130 made up of transmitters, receivers, and other circuitry (e.g., other than the transceiver(s) 1126/antenna(s) 1128 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1118 may include a timing management module 1132. The timing management module 1132 may be implemented via hardware, software, or combinations thereof. For example, the timing management module 1132 may be implemented as a processor, circuit, and/or instructions 1124 stored in the memory 1122 and executed by the processor(s) 1120. In some examples, the timing management module 1132 may be integrated within the processor(s) 1120 and/or the transceiver(s) 1126. For example, the timing management module 1132 may be implemented by a combination of software components (e.g., executed by a DSP or a general processor) and hardware components (e.g., logic gates and circuitry) within the processor(s) 1120 or the transceiver(s) 1126.

The timing management module 1132 may be used for various aspects of the present disclosure, for example, aspects of FIGS. 1-9. The timing management module 1132 is configured to configure multiple TAs for multi-TRP operation.

Embodiments contemplated herein include an apparatus comprising means to perform one or more elements of the methods shown in signal flow diagram 100 and signal flow diagram 600. This apparatus may be, for example, an apparatus of a UE (such as a wireless device 1102 that is a UE, as described herein).

Embodiments contemplated herein include one or more non-transitory computer-readable media comprising instructions to cause an electronic device, upon execution of the instructions by one or more processors of the electronic device, to perform one or more elements of the methods shown in signal flow diagram 100 and signal flow diagram 600. This non-transitory computer-readable media may be, for example, a memory of a UE (such as a memory 1106 of a wireless device 1102 that is a UE, as described herein).

Embodiments contemplated herein include an apparatus comprising logic, modules, or circuitry to perform one or more elements of the methods shown in signal flow diagram 100 and signal flow diagram 600. This apparatus may be, for example, an apparatus of a UE (such as a wireless device 1102 that is a UE, as described herein).

Embodiments contemplated herein include an apparatus comprising: one or more processors and one or more computer-readable media comprising instructions that, when executed by the one or more processors, cause the one or more processors to perform one or more elements of the methods shown in signal flow diagram 100 and signal flow diagram 600. This apparatus may be, for example, an apparatus of a UE (such as a wireless device 1102 that is a UE, as described herein).

Embodiments contemplated herein include a signal as described in or related to one or more elements of the methods shown in signal flow diagram 100 and signal flow diagram 600.

Embodiments contemplated herein include a computer program or computer program product comprising instructions, wherein execution of the program by a processor is to cause the processor to carry out one or more elements of the methods shown in signal flow diagram 100 and signal flow diagram 600. The processor may be a processor of a UE (such as a processor(s) 1104 of a wireless device 1102 that is a UE, as described herein). These instructions may be, for example, located in the processor and/or on a memory of the UE (such as a memory 1106 of a wireless device 1102 that is a UE, as described herein).

Embodiments contemplated herein include an apparatus comprising means to perform one or more elements of the methods shown in signal flow diagram 100 and signal flow diagram 600. This apparatus may be, for example, an apparatus of a base station (such as a network device 1118 that is a base station, as described herein).

Embodiments contemplated herein include one or more non-transitory computer-readable media comprising instructions to cause an electronic device, upon execution of the instructions by one or more processors of the electronic device, to perform one or more elements of the methods shown in signal flow diagram 100 and signal flow diagram 600. This non-transitory computer-readable media may be, for example, a memory of a base station (such as a memory 1122 of a network device 1118 that is a base station, as described herein).

Embodiments contemplated herein include an apparatus comprising logic, modules, or circuitry to perform one or more elements of the methods shown in signal flow diagram 100 and signal flow diagram 600. This apparatus may be, for example, an apparatus of a base station (such as a network device 1118 that is a base station, as described herein).

Embodiments contemplated herein include an apparatus comprising: one or more processors and one or more computer-readable media comprising instructions that, when executed by the one or more processors, cause the one or more processors to perform one or more elements of the methods shown in signal flow diagram 100 and signal flow diagram 600. This apparatus may be, for example, an apparatus of a base station (such as a network device 1118 that is a base station, as described herein).

Embodiments contemplated herein include a signal as described in or related to one or more elements of the methods shown in signal flow diagram 100 and signal flow diagram 600.

Embodiments contemplated herein include a computer program or computer program product comprising instructions, wherein execution of the program by a processing element is to cause the processing element to carry out one or more elements of the methods shown in signal flow diagram 100 and signal flow diagram 600. The processor may be a processor of a base station (such as a processor(s) 1120 of a network device 1118 that is a base station, as described herein). These instructions may be, for example, located in the processor and/or on a memory of the base station (such as a memory 1122 of a network device 1118 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method for a user equipment (UE), the method comprising:
receiving a radio resource control (RRC) signal from a network node comprising configuration information for multiple Timing Advance Group (TAG) identities (IDs);
determining TAG IDs based on the configuration information; and
configuring future communications based on TAGs associated with the TAG IDs.

2. The method of claim 1, wherein the configuration information comprises two independent TAG IDs.

3. The method of claim 1, wherein the configuration information comprises a first TAG ID, and wherein the method further comprises determining a second TAG ID based on the first TAG ID.

4. The method of claim 1, wherein a smaller TAG ID is used for a serving cell or an uplink transmission associated with coresetPoolIndex set to ‘0’ and a larger TAG ID is used for non-serving cell or an uplink transmission associated with coresetPoolIndex set to ‘1’.

5. The method of claim 1, further comprising receiving a timing advance command in a Random-Access Response (RAR) message, and wherein the RAR message includes a bit field indicating which of the two TAG IDs is associated with the timing advance command included in the RAR message.

6. The method of claim 1, further comprising determining that a TAG configuration is invalid for inter-band carrier aggregation when a single TAG is associated with different coresetPoolIndex values for different aggregated component carriers.

7. The method of claim 1, further comprising determining that a TAG configuration is invalid for intra-band carrier aggregation when component carriers use a different TAG.

8. The method of claim 1, further comprising receiving a timing advance command MAC-CE to update one or more timing advance values for one or more TAGS.

9. A user equipment (UE) comprising:
a processor; and
a memory storing instructions that, when executed by the processor, configure the UE to:
receive a radio resource control (RRC) signal from a network node comprising configuration information for multiple Timing Advance Group (TAG) identities (IDs);
determine TAG IDs based on the configuration information; and
configure future communications based on TAGs associated with the TAG IDs.

10. The UE of claim 9, wherein the configuration information comprises two independent TAG IDs.

11. The UE of claim 9, wherein the configuration information comprises a first TAG ID, and wherein the UE determines a second TAG ID based on the first TAG ID.

12. The UE of claim 9, wherein a smaller TAG ID is used for a serving cell or an uplink transmission associated with coresetPoolIndex set to ‘0’ and a larger TAG ID is used for non-serving cell or an uplink transmission associated with coresetPoolIndex set to ‘1’.

13. The UE of claim 9, wherein the instructions further configure the UE to receive a timing advance command in a Random-Access Response (RAR) message, and wherein the RAR message includes a bit field indicating which of the TAG IDs is associated with the timing advance command included in the RAR message.

14. The UE of claim 9, wherein the instructions further configure the UE to determine that a TAG configuration is invalid for inter-band carrier aggregation when a single TAG is associated with different coresetPoolIndex values for different aggregated component carriers.

15. The UE of claim 9, wherein the instructions further configure the UE to determine that a TAG configuration is invalid for intra-band carrier aggregation when component carriers use a different TAG.

16. The UE of claim 9, wherein the instructions further configure the UE to receive a timing advance command MAC-CE to update one or more timing advance values for one or more TAGS.

17. A method for a network node, the method comprising:
sending a radio resource control (RRC) signal to a user equipment (UE), the RRC signal comprising configuration information for multiple Timing Advance Group (TAG) identities (IDs);
determining a timing advance command to enable the UE to adjust its uplink transmission to better align with timing of the network node; and
sending the UE the timing advance command and indicating which TAG ID is associated with the timing advance command.

18. The method of claim 17, wherein the configuration information comprises two independent TAG IDs.

19. The method of claim 17, wherein the configuration information comprises a first TAG ID, and wherein the method further comprises determining a second TAG ID based on the first TAG ID.

20. The method of claim 17, wherein a smaller TAG ID is used for a serving cell or an uplink transmission associated with coresetPoolIndex set to ‘0’ and a larger TAG ID is used for a non-serving cell or an uplink transmission associated with coresetPoolIndex set to ‘1’.
